(19) United States
(12) Patent Application Publication
(10) Pub. No.: US 2006/0026367 A1
(43) Pub. Date: Feb. 2, 2006

(54) Storage task coordination apparatus method and system

(76) Inventors: Sanjoy Das, Palo Alto, CA (US); Sathees Babu Kodi, San Jose, CA (US); Sriram Palapudi, Santa Clara, CA (US); Michael Liang Tan, Union City, CA (US)

Correspondence Address: KUNZLER & ASSOCIATES, 8 EAST BROADWAY, SUITE 600, SALT LAKE CITY, UT, 84111, US

(21) Appl. No.: 10/899,914

(22) Filed: Jul. 27, 2004

(51) Int. Cl. G06F 12/00

(52) U.S. Cl. 711/154

(57) ABSTRACT

A system for automated execution of storage-related tasks includes a storage server configured to receive a storage task descriptor, initiate execution of a storage task corresponding to the storage task descriptor, and provide notification to one or more hosts in response to completion of the storage task. The storage server may also provide notification to the hosts in response to commencement of the storage task. The system also includes a host configured to receive the notifications and initiate execution of one or more local tasks in response to receiving the notifications. In certain embodiments, notifications occur through notification messages that contain a local task descriptor describing the tasks to be performed on the host. The present invention facilitates coordinated execution of storage-related tasks associated with storage devices with application-related tasks executing on a host.

### BACKGROUND OF THE INVENTION

1. Field of the Invention

The present invention relates to data processing and system management. Specifically, the invention relates to apparatus, methods, and systems for automated execution of storage-related tasks and coordination of such tasks with host-related tasks.

2. Description of the Related Art

It is frequently desirable to replicate or ‘clone’ an entire data processing site or system including various applications and data associated therewith to another site or system. Once such a site or system is up and running, the ability to conduct storage backup and data replication activities while simultaneously executing applications that access that data is also frequently desirable. A significant issue in conducting such activities is maintaining the integrity of storage data that is accessed by applications executing on a host or the like. Often, such data is stored on a shared storage subsystem and/or accessed via a shared network of storage servers and subsystems. Such a shared arrangement, while providing certain advantages, complicates the issue of managing storage data and maintaining data integrity.

Currently, cloning a system or conducting backup operations while continuing to conduct data processing activities requires that great care be exercised to ensure that host-related activities and storage-related activities are conducted in a coordinated, safe, and orderly manner. Typically, such activities require conducting a complicated sequence of steps either manually, or via a number of scripts that are manually initiated and coordinated.

FIG. 1 is a block diagram depicting one example of a data processing environment 100 further illustrating the issues related to coordinating host-based activities with storage-based activities. As used within this specification and the associated claims, the terms ‘host’, ‘host-related’, and ‘host-based’ are to be broadly interpreted and refer to computing devices or systems such as workstations, mainframes, handheld devices, or servers that request services of storage-based devices or systems. FIG. 1 is one common example of such an arrangement but is not intended to be definitive of such an arrangement.

As depicted, the data processing environment 100 includes several sites 110 with hosts 120 interconnected with a data network 130 and a storage network 140. The sites 110 may be geographically disperse or centrally located at a common facility. While the depicted arrangement shows sites 110 that are substantially identical in structure (with unique dedicated purposes such as development, quality assurance, production, and recovery) the present invention may also be deployed in less structured environments.

In the depicted arrangement, one or more storage servers 150 and storage subsystems 160 are also connected to the storage network 140. The data network 130 facilitates processing related data communications between the various hosts 110 or other data processing equipment. The data network 130 may be a local area network, a wide area network, or an inter-network such as the internet. The storage network 140 may be dedicated to bearing storage-related data communications such as data transfers to and from the storage servers 150 and the storage subsystems 160.

A separate network for storage-related communications is an increasing phenomenon in data processing environments and provides many advantages such as increased flexibility, traffic balancing, scalability of both processing power and storage capacity, superior packaging options, and the like. However, the flexible and decoupled nature of such an arrangement also increases the complexity of identifying and managing storage data associated with specific hosts and applications.

The data processing environment 100 may assume a variety of forms. However, regardless of whether geographically dispersed or centrally located, structured or unstructured, the requirement to manually coordinate host-related activities and storage-related activities often results in lost data, increased system downtime, and lost business opportunity.

Given the aforementioned issues and challenges related to coordinating host-related tasks and storage-related tasks and the shortcomings of currently available solutions, a need exists for an apparatus, method, and system for automated execution of storage-related tasks. Beneficially, such an apparatus, method, and system would reduce the complexity and errors associated with cloning data processing systems and replicating application data stored on storage devices.

### SUMMARY OF THE INVENTION

The present invention has been developed in response to the present state of the art, and in particular, in response to the problems and needs in the art that have not yet been fully solved by currently available data processing and system management means and methods. Accordingly, the present invention has been developed to provide an apparatus, method, and system for automated execution of storage-related tasks that overcome many or all of the above-discussed shortcomings in the art.

Specifically, the present invention sets forth an apparatus, method, and system for automated execution of storage-related tasks in a manner that facilitates coordinated execution with host-related tasks. In one aspect of the present invention, an apparatus for automated execution of storage-related tasks includes an application agent that initiates a storage task via a storage server, receives notification of completion of the storage task, and initiates execution of a local task in response to receiving notification of completion of the storage task. The application agent may reside on a host or the like and also initiate execution of a local task in response to receiving notification of commencement of the storage task and generate a storage task descriptor on behalf of one or more applications residing on the host.

In certain embodiments, the notification messages may include a local task descriptor that specifies the tasks to be executed on the system receiving the notification message. The application agent may be further configured to parse the local task descriptor and execute the described tasks.

In another aspect of the present invention, an apparatus for automated execution of storage-related tasks includes a storage agent that receives a storage task descriptor, initiates execution of a storage task corresponding to the storage task descriptor, and provides notification of completion of the storage task in response to completion of the storage task. The storage agent may also provide notification of initiation of the storage task in response to initiation of the storage task.

In another aspect of the present invention, an apparatus for automated execution of storage-related tasks includes an application coordinator that generates a storage task descriptor, provides the storage task descriptor to a storage server, and provide a local task descriptor to an application agent in response to receiving notification of completion of a storage task corresponding to the storage task descriptor. The application coordinator may also provide a local task descriptor to the application agent in response to notification of initiation of the storage task. In response, the application agent may receive the local task descriptor and execute a local task corresponding to the local task descriptor.

The coordination messages (such as initiation and notification messages) that are used by the application agent, application coordinator, and storage agent to coordinate storage tasks with application or host tasks may be communicated via sockets. In one embodiment, the coordination messages conform to an XML syntax and may be parsed via an XML parser. Using sockets and an XML syntax facilitates communicating in a flexible platform-independent manner.

In another aspect of the present invention, a method for automated execution of storage-related tasks (from the perspective of a host or the like) includes initiating a storage task via a storage server, receiving notification on at least one host of completion of the storage task, and executing a local task in response to completion of the storage task. The method may also include executing a local task in response to initiation of the storage task.

In another aspect of the present invention, a method for automated execution of storage-related tasks (from the perspective of a storage server or the like) includes receiving a storage task descriptor, executing a storage task corresponding to the storage task descriptor, and providing notification to one or more hosts in response to completion of the storage task. The method may also include providing notification one or more hosts in response to initiation of the storage task.

In another aspect of the present invention, a method for automated execution of storage-related tasks (from the perspective of a coordination server or the like) includes generating a storage task descriptor, providing the storage task descriptor to a storage server, and providing a local task descriptor to an application agent in response to receiving notification of completion of the storage task.

Various elements of the present invention may be combined into a system arranged to carry out the functions or steps presented above. In one embodiment, the system includes a storage server configured to receive a storage task descriptor, initiate execution of a storage task corresponding to the storage task descriptor, and provide notification to one or more hosts in response to completion of the storage task. The storage server may also provide notification to the hosts in response to notification of commencement of the storage task.

The system may also include a computing device or system such as a host that receives notification of completion of the storage task and initiates execution of a local task in response to receiving notification of completion of the storage task. In certain embodiments notification occurs through notification messages that contain a local task descriptor describing the tasks to be performed on the host.

In certain embodiments, the system also include a coordination server that generates a storage task descriptor, provides the storage task descriptor to a storage server, and provides a local task descriptor to an application agent in response to receiving notification of completion of the storage task.

The present invention facilitates coordinated execution of storage-related tasks associated with storage devices with application-related tasks executing on a host or the like. These and other features and advantages of the present invention will become more fully apparent from the following description and appended claims, or may be learned by the practice of the invention as set forth hereinafter.

It should be noted that the terms ‘host’, ‘host-related’, and ‘host-based’ are broadly interpreted within this specification and refer to computing devices or systems such as workstations, mainframes, handheld devices, or servers that request services of storage-based devices or systems. It should also be noted that references to features, advantages, or similar language does not imply that all of the features and advantages that may be realized with the present invention should be or are encompassed within any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting one example of a data processing environment in which the present invention may be deployed;

FIG. 2a is a block diagram depicting one example of a storage task coordination system of the present invention;

FIG. 2b is a block diagram further depicting one example of a storage task coordination system of the present invention;

FIG. 3 is a flow chart diagram depicting one example of a storage task coordination method of the present invention from the perspective of a host;

FIG. 4 is a flow chart diagram depicting one example of a storage task coordination method of the present invention from the perspective of a storage server; and

FIG. 5 is a text diagram depicting one example of a storage task descriptor of the present invention; and

FIG. 6 is a text diagram depicting one example of various application related data structures of the present invention.

### DETAILED DESCRIPTION OF THE INVENTION

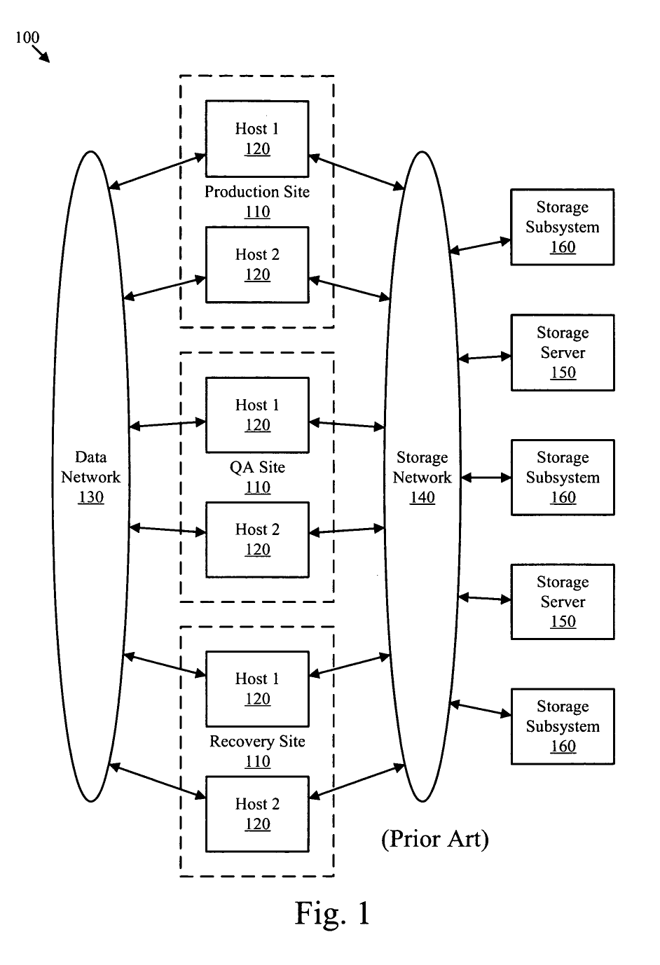

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in FIGS. 1 through 6, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The features, structures, or characteristics of the invention described throughout this specification may be combined in any suitable manner in one or more embodiments. For example, reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” or similar language throughout this specification do not necessarily all refer to the same embodiment and the described features, structures, or characteristics may be combined in any suitable manner in one or more embodiments.

The present invention sets forth an apparatus, system and method for automated execution of storage-related tasks in a manner that facilitates coordinated execution with host-related tasks. As used within this specification and the associated claims the phrase ‘storage-related tasks’ refer to tasks or operations primarily related to storing and retrieve data on storage devices or systems such as disk drives or storage networks. Conversely, the phrase ‘host-related tasks’ refers to activities or operations conducted on computing devices or systems such as workstations, mainframes, handheld devices, or servers that invoke or use storage services from other devices and systems.

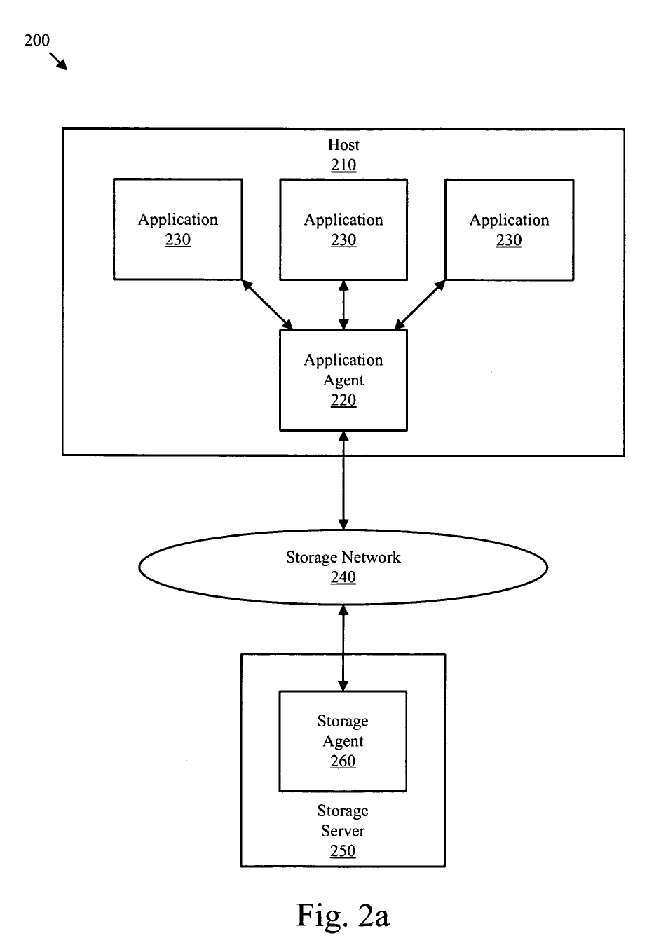

FIG. 2a is a block diagram depicting one example of a storage task coordination system 200 of the present invention. As depicted, the storage task coordination system 200 includes a host 210 configured with an application agent 220 and one or more applications 230, a storage network 240, and a storage server 250 configured with a storage agent 260. The task coordination system 200 facilitates conducting host-related and storage-related tasks in a coordinated manner.

As depicted, the host 210 may be any type of computing platform capable of executing (i.e. hosting) applications, and the storage server 250 may be any type of storage-related device capable of servicing storage-related requests. The application agent 220 on the host 210 and the storage agent 260 on the storage server 250 coordinate host-related or application-related tasks conducted on the host 210 with storage-related tasks conducted on the storage server 250 or similar equipment.

In certain embodiments, coordination between the application agent 220 and the storage agent is achieved via notification messages that indicate that a particular task has been initiated or completed. For example, the storage agent 260 may send an SNMP message informing the host 210 (via the application agent 220) along with other hosts and servers that a replication task involving a particular set of volumes has commenced. In turn, the application agent may initiate certain host-related tasks that require commencement of that particular replication task previous to successful execution. In one embodiment, a local task descriptor (not shown) is included in the message received by the application agent 220 and the application agent 220 invokes the tasks specified by the local task descriptor.

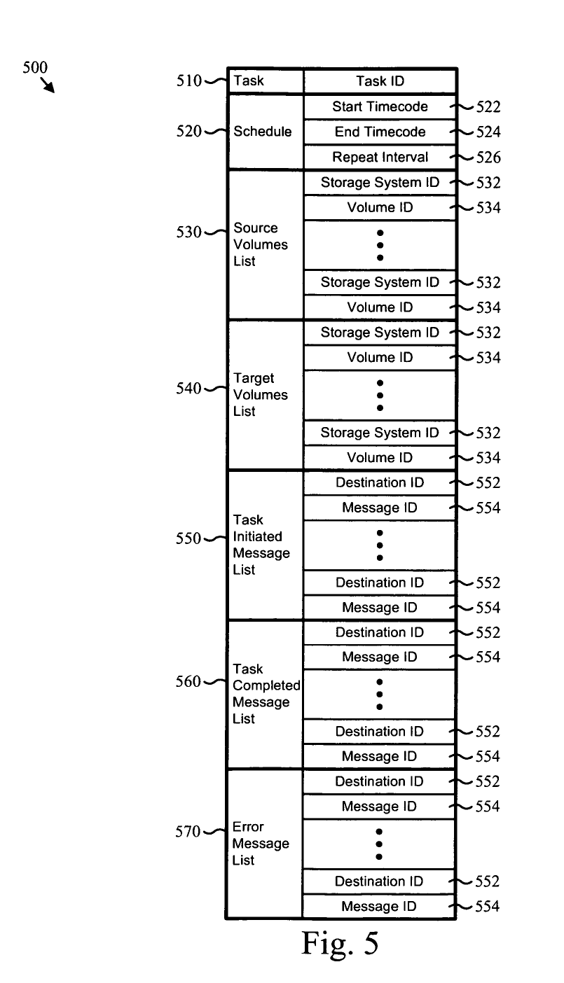

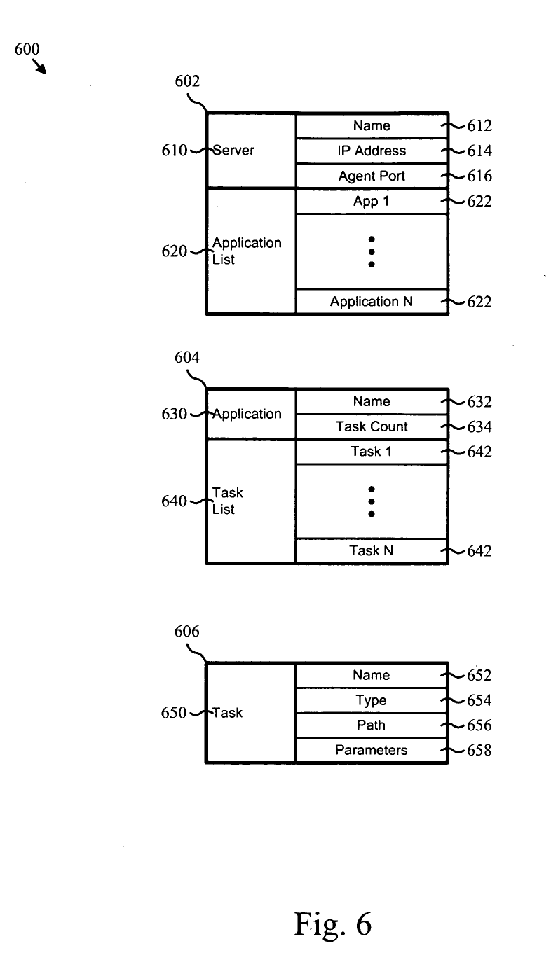

FIG. 2b is a block diagram further depicting one example of a storage task coordination system 200 of the present invention. In certain embodiments, the storage task coordination system 200 includes an application coordinator 270 that coordinates the efforts of multiple application agents 220. For example, in one embodiment the application coordinator 270 resides on a dedicated server and is responsible for interfacing to one or more storage agents 260 to initiate storage-related tasks and is also responsible for creating and managing data structures that describe (host-related) tasks that may be executed by one or more application agents 220. Inclusion of the application coordinator 270 may reduce the complexity of coordinating activities on multiple hosts or servers with storage-related tasks on storage devices. FIGS. 5 and 6 describe specific data structures that may be managed by the application coordinator 270.

The data structures created by the application coordinator 270 may be encoded in an XML format and sent via the various initiation messages and notification messages to the application agents and the storage agent in order to coordinate storage-related tasks and application or host-based tasks. In certain embodiments, the messages are communicated via sockets. Using sockets and an XML format facilitates communicating in a flexible platform-independent manner such that the coordinator and the agents may be hosted on different operating systems.

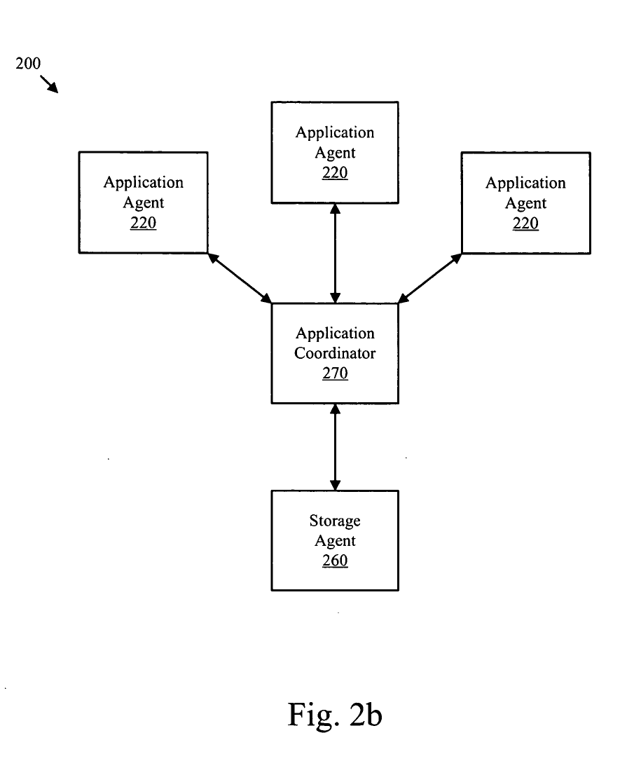

FIG. 3 is a flow chart diagram depicting one example of a storage task coordination method 300 of the present invention from the perspective of a host. As depicted, the storage task coordination method 300 includes requesting (310) a storage task, waiting (320) for notification that the storage task has commenced, executing (330) one or more host-related tasks, waiting (340) for notification that the storage task has completed, and executing (350) one or more host-related tasks. The storage task coordination method 300 facilitates coordinated execution of storage-related tasks and host-related tasks.

In one embodiment, requesting (310) a storage task includes sending a storage task descriptor to one or more storage agents. The storage task descriptor may detail the requested operation and the particular volumes involved with the operation as well as a listing of application agents to be informed of initiation, completion, and error events associated with the storage tasks. In another embodiment, requesting (310) includes invoking a remote procedure call.

Waiting (320) for notification that the storage task has commenced and waiting (340) for notification that the storage task has completed may include suspending a process, polling a status indicator, scheduling an event, or similar operation appropriate to the particular processing system. Likewise, executing (330) and executing (350) one or more host-related tasks may involve launching or scheduling a particular application, sending a process semaphore, unblocking a process, or similar operation appropriate to the particular processing system. In certain embodiments the host-related tasks are specified within the notification messages received in steps 320 and 340. Regardless of the particulars of various systems and embodiments and the manner in which notification occurs, the storage task coordination method 300 facilitates conducting host-related or application-related tasks in a synchronized manner with storage-related tasks.

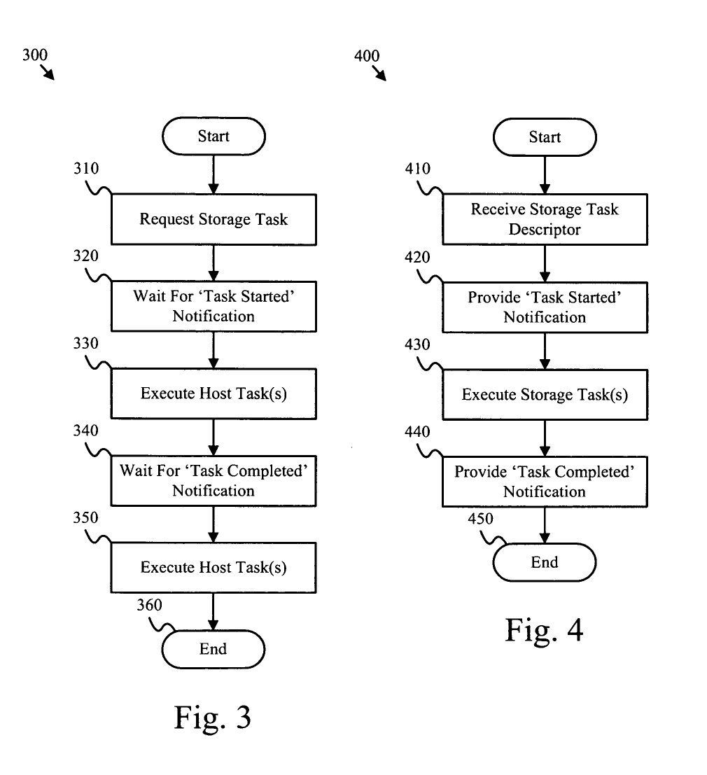

FIG. 4 is a flow chart diagram depicting one example of a storage task coordination method 400 of the present invention from the perspective of a storage server. As depicted, the storage task coordination method 400 includes receiving (410) a descriptor, providing notification (420) of task initiation, executing (430) one or more storage-related tasks, and providing notification (440) of task completion. Similar to method 300, the storage task coordination method 400 facilitates coordinated execution of host-related tasks with storage-related tasks from the perspective of a storage server, storage subsystem, or the like.

As depicted, the method 400 begins by receiving (410) a storage task descriptor detailing the storage-related tasks to be performed on various storage devices that are accessible via the storage network 140 or the like. For example, the task descriptor may describe steps to take one or more storage volumes offline, perform various data replication and management tasks and bring various storage volumes online—or conduct similar tasks. The storage task descriptor may also detail the time and conditions under which the task should be (or should not be) performed.

Once the conditions for conducting a storage task have been met, the method proceeds by providing notification (420) of task initiation and executing (430) the tasks detailed by the storage task descriptor. Subsequently, the method continues by providing notification (440) of task completion and terminating (450).

FIG. 5 is a text diagram depicting one embodiment of a storage task descriptor 500 of the present invention. As depicted, the storage task descriptor 500 includes a task indicator 510, a schedule 520, a source volume list 530, a target volume list 540, a task initiated list 550, a task completed list 560, and an error message list 570. The storage task descriptor 500 is one example of a data format that may be used by the application agent 220 and the storage agent 260 to facilitate coordination of host-related or application-related tasks with storage-related tasks.

The task indicator 510 indicates the storage-related task to be performed on a storage device, storage subsystem, storage network, or the like. In the depicted embodiment, the task indicator 510 is a handle such as a pointer that may be used to reference additional details about the task not included in the storage task descriptor 500. The schedule 520 indicates certain time constraints that may be imposed on the storage task. In the depicted embodiment, the schedule 520 includes a start timecode 522, an end timecode 524, and a repeat interval 526. The information in the depicted schedule 520 facilitates conducting repetitive tasks such as conducting a weekly backup in coordination with application-related tasks such as running a weekly sales report.

The source volume list 530 indicates the source volumes (if any) involved in the storage-related task. Likewise, the target volume list 540 indicates the target volumes (if any) involved in the storage-related task. In the depicted embodiment, each source volume and target volume is specified with a storage system identifier 532 and a volume identifier 534.

The task initiated list 550, task completed list 560, and error message list 570 indicate the messages and message destinations associated with initiation, completion, and errors events that occur in conjunction with executing the storage-related tasks defined by the storage task descriptor 500. In the depicted embodiment, messages are specified with a message identifier 554, and message destinations are specified with a destination identifier 552. The message identifier 554 and the destination identifier 552 may be handles such as pointers that reference more extensive information.

The depicted storage task descriptor 500 facilitates coordinated execution of storage-related tasks conducted on storage devices and the like with host-related or application-related tasks conducted on computing devices. A similar structure or format may be used to specify host-related tasks. In one embodiment, one or more local task descriptors (not shown) are included within the storage task descriptor and sent (as an SNMP message or the like) to specified destinations in lists 550, 560, and 570 in response to initiation, completion, or error events. Under such an arrangement, the application agents 220 executing on the specified hosts may be configured to parse the received messages and conduct the indicated local tasks.

FIG. 6 is a text diagram depicting one example of various application related data structures of the present invention. The depicted data structures 600 include a processing node descriptor 602, an application descriptor 604, and a task descriptor 606. The depicted data structures 600 may be generated by the application coordinator 270 and used to initiate application or host-related tasks via the application agents 220.

The depicted processing node descriptor 602 includes a server descriptor 610 and an application list 620. The server descriptor 610 describes the server or host to which the application list 620 applies. In the depicted embodiment, the server descriptor 610 includes a server or host name 612, an IP address 614, and a port 616 to which communications for the application agent 220 are to be directed.

The application list 620 specifies the applications or similar executable units such as system utilities that correspond to the specified server or host. In the depicted embodiment, the application list 620 is a set of handles or pointers 622 to application descriptors 604. In another embodiment, the application list 620 is a set of offsets into an execution table or similar construct.

The depicted application descriptor 604 includes an application indicator 630 comprising a name indicator 632 and a task count 634. In the depicted structure, the task count 634 corresponds to the length of the task list 640. The depicted task list 640 is a set of handles or pointers 642 to task descriptors 606.

The depicted task descriptor 606 is essentially a task indicator 650 which in the depicted embodiment comprises a task name 652, a task type 654, a path 656, and a parameter list 658. The fields of the task indicator 650 facilitate launching or invoking the task as is familiar to those of skill in the art.

The present invention facilitates coordinated execution of storage-related tasks with local tasks such as host-related tasks. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for automated execution of storage-related tasks, the apparatus comprising:
an application agent configured to initiate a remotely-executed storage task;
the application agent further configured to receive notification of completion of the storage task; and
the application agent further configured to initiate execution of a local task in response to receiving notification of completion of the storage task.

2. The apparatus of claim 1, further comprising a socket configured to receive coordination messages.

3. The apparatus of claim 2, wherein the coordination messages comprise XML statements.

4. The apparatus of claim 1, wherein the notification of completion comprises a local task descriptor.

5. The apparatus of claim 1, further comprising an application coordinator configured to conduct communications with a storage agent on behalf of a plurality of application agents.

6. The apparatus of claim 5, wherein the application coordinator is further configured to generate a storage task descriptor.

7. The apparatus of claim 5, wherein the application coordinator is further configured to generate a local task descriptor for the application agent.

8. The apparatus of claim 1, further comprising a storage agent configured to receive a storage task descriptor, initiate execution of a storage task corresponding to the storage task descriptor, and provide notification to the application agent in response to completion of the storage task.

9. The apparatus of claim 1, wherein the application agent is further configured to receive notification of initiation of the storage task.

10. The apparatus of claim 9, wherein the application agent is further configured to initiate execution of a local task in response to receiving the notification of initiation of the storage task.

11. An apparatus for automated execution of storage-related tasks, the apparatus comprising:
a storage agent configured to receive a storage task descriptor;
the storage agent further configured to initiate execution of a storage task corresponding to the storage task descriptor; and
the storage agent further configured to provide notification of completion of the storage task in response to completion of the storage task.

12. The apparatus of claim 11, further comprising a socket configured to receive coordination messages.

13. The apparatus of claim 12, wherein the coordination messages comprise XML statements.

14. The apparatus of claim 11, further comprising an application coordinator configured to generate the storage task descriptor, receive the notification of completion of the storage task, and communicate a local task descriptor to an application agent in response to receiving the notification of completion of the storage task.

15. The apparatus of claim 11, wherein the storage agent is further configured to provide notification of initiation of the storage task in response to initiation of the storage task.

16. The apparatus of claim 11, further comprising an application coordinator configured to generate the storage task descriptor, receive the notification of initiation of the storage task, and communicate a local task descriptor to an application agent in response to receiving the notification of initiation of the storage task.

17. The apparatus of claim 11, further comprising an application agent configured to receive a local task descriptor and initiate execution of a local task.

18. A method for automated execution of storage-related tasks, the method comprising:
initiating a remotely-executed storage task;
receiving notification of completion of the storage task; and
initiating execution of a local task in response to receiving notification of completion of the storage task.

19. An apparatus for automated execution of storage-related tasks, the apparatus comprising:
means for initiating a remotely-executed storage task;
means for receive notification of completion of the storage task; and
means for initiating execution of a local task in response to receiving notification of completion of the storage task.

20. A system for automated execution of storage-related tasks, the system comprising:
a storage server configured to receive a storage task descriptor, initiate execution of a storage task corresponding to the storage task descriptor, and provide notification of completion of the storage task in response to completion of the storage task;
an application agent configured to initiate execution of a local task in response to receiving notification of completion of the storage task; and
a coordination server configured to conduct communications with the storage server on behalf of the application agent.

21. A signal bearing medium tangibly embodying a program of machine-readable instructions executable by a digital processing apparatus to perform operations for automated execution of storage-related tasks, the operations comprising:
an operation to initiate a remotely-executed storage task;
an operation to receive notification of completion of the storage task; and
an operation to initiate execution of an application task in response to receiving notification of completion of the storage task.

22. The signal bearing medium of claim 21, wherein the notification of initiation occurs via a socket.

23. The signal bearing medium of claim 22, wherein the notification of initiation comprises XML statements.

24. The signal bearing medium of claim 21, wherein the notification of completion comprises a local task descriptor.

25. The signal bearing medium of claim 21, wherein the operations further comprise an operation to parse the notification of completion.

26. The signal bearing medium of claim 21, wherein the operations further comprise an operation to receive notification of initiation of the storage task.

27. The signal bearing medium of claim 21, wherein the operations further comprise an operation to initiate execution of a local task in response to receiving notification of initiation of the storage task.
